(19) United States
(12) Patent Application Publication
(10) Pub. No.: US 2023/0002961 A1
(43) Pub. Date: Jan. 5, 2023

(54) GRAPHENE-IMPREGNATED MICROFIBER FABRIC

(71) Applicant: Microsoft Technology Licensing, LLC, Redmond, WA (US)

(72) Inventors: Barbara Staatz NICHOLSON, Mercer Island, WA (US); Patrick T GAULE, Bothell, WA (US); Aditha May ADAMS, Seattle, WA (US); James Alec ISHIHARA, Bellevue, WA (US); Jing CAO, Portland, OR (US); Erica Lynn ARNOLD, Seattle, WA (US); Christopher Luke BATES, Seattle, WA (US)

(73) Assignee: Microsoft Technology Licensing, LLC, Redmond, WA (US)

(21) Appl. No.: 17/364,696

(22) Filed: Jun. 30, 2021

(51) Int. Cl. D06M 11/74; D06M 15/564; H01B 1/24

(52) U.S. Cl. CPC D06M 11/74; D06M 15/564; H01B 1/24; D06M 2101/32

(57) ABSTRACT

Graphene-impregnated microfiber fabrics and methods for producing such fabrics are disclosed. In one example, a method of producing a graphene-impregnated microfiber fabric comprises providing a microfiber substrate comprising polymer fibers. Graphene is mixed into a polymer-based dispersion to create a graphene-impregnated polymer-based dispersion. The graphene-impregnated microfiber fabric is formed by immersing the microfiber substrate in the graphene-impregnated polymer-based dispersion to coat the polymer fibers of the substrate with the graphene and the polymer of the polymer-based dispersion. The fabric is removed from the dispersion and dried.

### BACKGROUND

Textiles are widely used in various consumer products, including consumer electronics, furniture, apparel, automobiles, accessories, and devices. Textiles may take the form of knit, woven, and microfiber fabrics. As more textiles become integrated with everyday use items, demand for functional characteristics provided by textiles increases.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed relating to graphene-impregnated microfiber fabric and methods of producing graphene-impregnated microfiber fabric. In some examples, a graphene-impregnated microfiber fabric comprises a microfiber substrate comprising polymer fibers, graphene coating the polymer fibers, and a polymer material coating the polymer fibers and bonding the graphene to the polymer fibers.

In some examples, a method of producing a graphene-impregnated microfiber fabric comprises providing a microfiber substrate comprising polymer fibers. Graphene is mixed into a polymer-based dispersion to create a graphene-impregnated polymer-based dispersion. The graphene-impregnated microfiber fabric is formed by immersing the microfiber substrate in the graphene-impregnated polymer-based dispersion to coat the polymer fibers of the substrate with the graphene and the polymer of the polymer-based dispersion. The graphene-impregnated microfiber fabric is removed from the graphene-impregnated polymer-based dispersion and then dried.

In some examples, a method of producing a graphene-impregnated microfiber fabric comprises providing a microfiber substrate comprising polyester fibers. A graphene-based paste comprising graphene nanoplatelets is mixed into a polyurethane-based dispersion to create a graphene-impregnated polyurethane-based dispersion. The graphene-impregnated microfiber fabric is formed by immersing the microfiber substrate in the graphene-impregnated polyurethane-based dispersion to coat the polyester fibers of the substrate with the graphene nanoplatelets and polyurethane. The graphene-impregnated microfiber fabric is removed from the graphene-impregnated polyurethane-based dispersion and then dried.

### BRIEF DESCRIPTION OF THE DRAWINGS

FIG. 1 shows various examples for microfiber fabric incorporated into electronic devices.

FIG. 2 shows a flow diagram of an example method of forming a graphene-impregnated microfiber fabric according to examples of the present disclosure.

FIG. 3 schematically shows a flow diagram of another example method of forming a graphene-impregnated microfiber fabric according to examples of the present disclosure.

FIG. 4 shows an electron microscope image of an example graphene-impregnated microfiber fabric according to examples of the present disclosure.

### DETAILED DESCRIPTION

As mentioned above, manufacturers are more frequently utilizing textiles in a wide variety of consumer products. Textiles can be made by knitting, weaving, or using other suitable techniques to manipulate yarns and form them into fabric. In some examples, nonwoven fabrics, which are neither woven nor knitted, may be formed by bonding fibers together using chemical, mechanical, heat, and/or solvent treatment.

Microfiber fabrics made from synthetic fibers may sometimes be used instead of natural fibers in textiles, as they can provide various desirable characteristics, including but not limited to softness, durability, light weight, water absorption, water repellence, and wrinkle resistance, depending on the specific synthetic fibers and methods for making the microfiber. A microfiber may be defined as a fiber or filament that has a fineness of less than one denier; e.g., a fiber or filament having a linear mass density of less than one gram per 9000 meters of the fiber or filament. Microfibers can be used to form non-woven, woven, and knit fabrics in various configurations for different product needs.

With textiles becoming more prevalent and desirable in consumer products, such as wearables or parts of electronic devices, there is an increasing demand for fabrics that offer useful characteristics for such consumer products. For example, it may be desirable for fabrics used in products that are intended to be worn or touched to be flexible, microbe- and virus-resistant, soft to the touch, visually attractive, thermally conductive, and/or relatively strong. Further, many textiles are becoming increasingly integrated with sensors to create “smart textiles” that help provide universal seamless experiences for users. Thus, it may also be desirable for fabrics to be conductive.

Currently, to provide additional desired characteristics to a textile for a product, such as conductivity, flexibility, antimicrobial and antiviral properties, added strength, durability, etc., manufacturers may perform treatments on the textile. For example, a thin layer of a metallic material, such as nano-silver or graphene, may be printed or adhered to the outer surface of a fabric to impart conductive properties to the fabric However, adding such additional layer(s) of material may add undesired thickness to the fabric, increase production costs, and/or negatively affect the feel, texture, and appearance of the fabric. Further, these techniques merely apply an additional exterior layer and do not evenly distribute the material throughout the entire thickness of the fabric. Printed graphene, for example, may not be durable and can wear off over time. Additionally, current methods to create conductive/performance enhancing textiles also contribute to environmental degradation (i.e. mining rare earth metals, releasing additional solvents into the atmosphere etc.).

Accordingly, examples are disclosed herein that relate to incorporating graphene into microfiber fabric at the polymer processing level of the fabric. Briefly, graphene may be added to a polymer-based dispersion in which a microfiber substrate is immersed to coat the microfibers of the substrate with the graphene and polymer. In this manner, the graphene may be bonded to the microfibers by the polymer of the polymer-based dispersion. The disclosed methods may help to impregnate and distribute graphene evenly and thoroughly throughout the microfibers and thus become embedded into and throughout the fabric itself, rather than merely being applied as a discrete exterior layer. The graphene-impregnated microfiber substrate may then be subsequently processed in manners known in the microfiber industry to form the final fabric.

In different examples, graphene utilized in the methods and graphene-impregnated fabrics of the present disclosure may take the form of pure or substantially pure graphene that is one atomic layer thick (i.e., a monolayer sheet of carbon), multi-layer graphene comprising multiple layers, graphene nanoplatelets comprising stacks of graphene sheets, and various combinations of the foregoing. In some examples and as described in more detail below, methods and graphene-impregnated fabrics of the present disclosure utilize graphene nanoplatelets to enhance one or more desirable properties, such as electrical and thermal conductivity, while also preserving the thermal and biological stability of the graphene. In different examples, a variety of different commercial forms of graphene may be utilized in the methods and graphene-impregnated fabrics of the present disclosure, including but not limited to graphene oxide, reduced graphene oxide, and graphene nanoplatelets (as noted above).

As described in more detail below, the resulting graphene-impregnated microfiber fabric exhibits advantageous qualities including but not limited to electrical conductivity, thermal conductivity, antimicrobial, antibacterial and antiviral properties, increased abrasion resistance, increased strength (in some examples, a tensile strength of approximately 100 times greater than steel), anti-static properties, flame-retardant and flame-extinguishing properties, anti-odor properties, and light weight, all while retaining substantially the same texture and appearance of the microfiber fabric absent such graphene, and without adding thickness to the fabric.

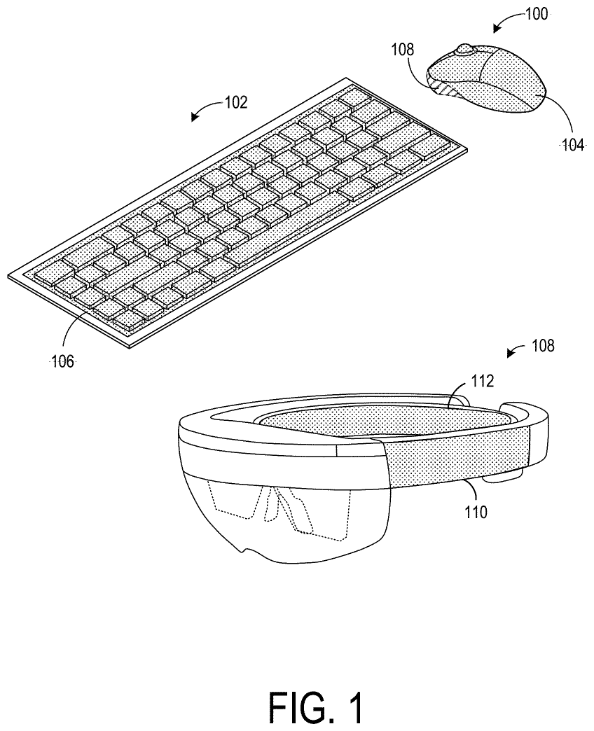

FIG. 1 shows examples of graphene-impregnated microfiber fabric incorporated into a mouse 100, a mouse cover 104, and into a keyboard 102 as a keyboard cover 106, and further into a head-mounted display device 108 as part of the head band at regions 110 and 112, where the graphene-impregnated microfiber fabric may be formed via the graphene impregnation methods disclosed herein. In these and many other consumer-oriented devices, users handling and touching such devices may be exposed to bacteria, viruses, fungi, and other microbes or pathogens on device surfaces. Advantageously, and as described in more detail below, the antimicrobial/antiviral properties of the graphene-impregnated microfiber fabric may help to prevent the buildup of harmful microbes and viruses without the use of sanitation products. Further, the electrical and thermal conductivity of the graphene-impregnated microfiber fabric may allow sensors, actuators, light-emitting devices, energy storage devices, and other electronic components to be integrated into or electrically coupled to the surfaces of the mouse 100 and keyboard 102. For example, sensors may include touch sensors, temperature sensors, pressure sensors, and biometric sensors.

In some examples, a device incorporating graphene-impregnated microfiber fabric may include “keep-out” regions that are not electrically conductive (to reduce antenna interference, for example). As one example, mouse cover 104 includes a non-conductive keep-out region 108. Keep-out region 108 may lack conductivity as a result of the fabric of the cover 104 in that region being impregnated with a smaller amount or no amount of graphene. As another example, a graphene-impregnated microfiber fabric cover for a laptop may include an electrically-conductive touchpad portion of graphene-impregnated fabric coupled to touch input circuitry, where the touchpad portion is surrounded by a non-graphene portion that is not conductive. Even in examples where a graphene-impregnated microfiber fabric is not conductive (e.g., contains an amount of graphene below a threshold), the fabric may still exhibit other advantageous properties offered by graphene, as mentioned above. Additionally, utilizing graphene to enable different material properties in different areas of the textile (i.e. microfiber areas that are conductive vs. areas that are not conductive) will enable the use of a simpler recycling stream. In some examples, all of such textiles may be recycled together as opposed to separating and separately recycling multiple substrates and additional electronic components.

As noted, graphene-impregnated microfiber fabric produced according to the examples disclosed herein may be used in a range of many different applications. Examples of products that can incorporate graphene-impregnated microfiber fabric include but are not limited to computing devices (e.g., laptops, smartphones, tablets, head-mounted display devices, other wearable computing devices, etc.), input devices (e.g., mice, joysticks, etc.), automobiles (e.g., seats, electronic dashboards, steering wheels), aircraft, apparel, devices in the healthcare industry (temperature, heart-rate, blood-pressure, and other biometric-monitoring devices, diagnostic wearable devices), furniture, headphones, and book covers.

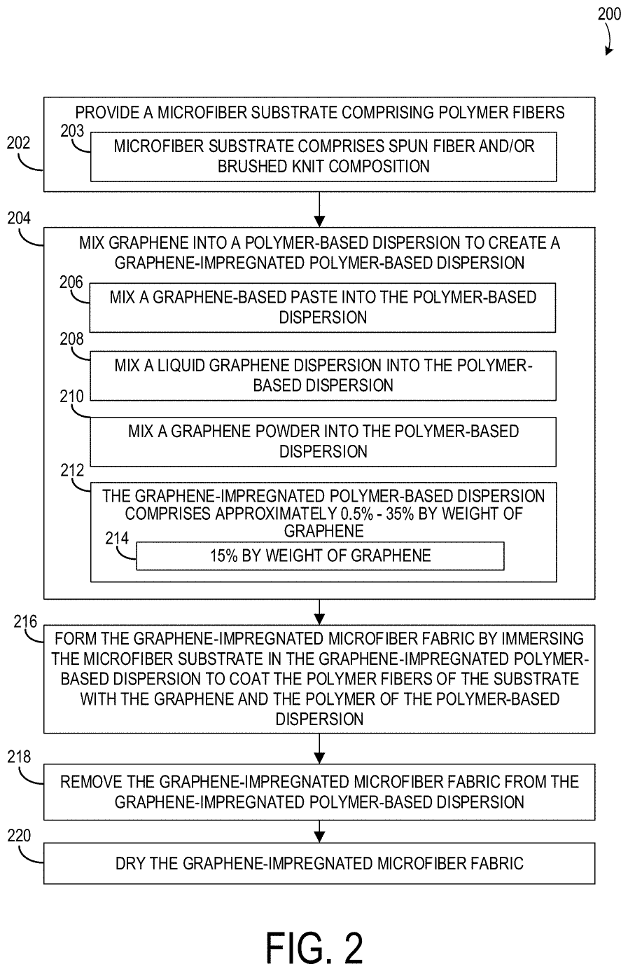

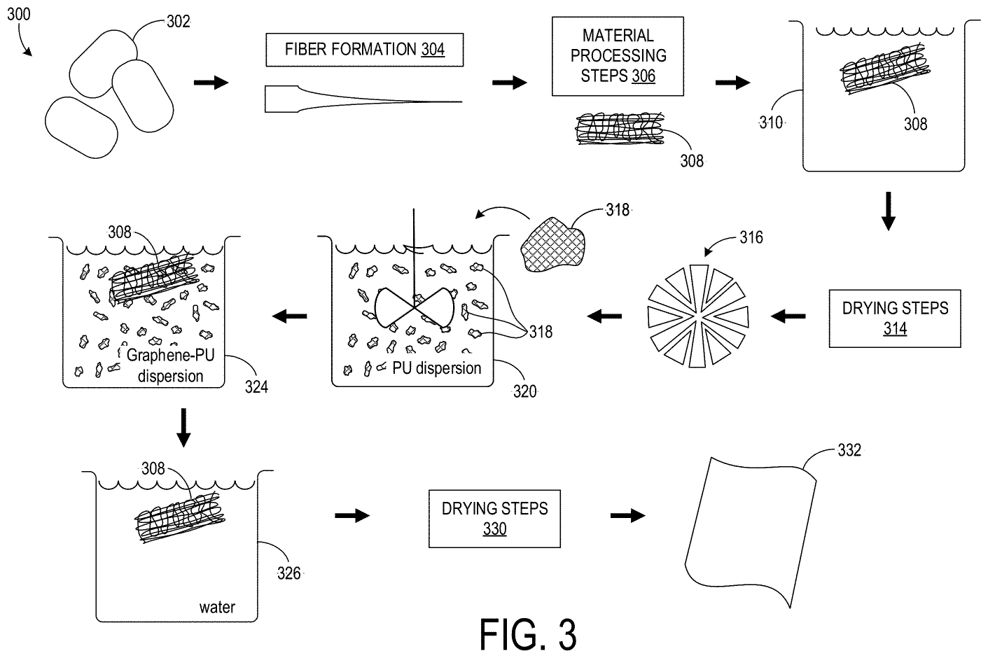

As mentioned above, and in one potential advantage of the present disclosure, graphene may be impregnated into a microfiber fabric at the polymer processing level of the fabric. FIG. 2 shows an example method 200 of forming a graphene-impregnated microfiber fabric according to examples of the present disclosure. FIG. 3 shows a schematic flow diagram of one example of a more detailed method 300 of manufacturing a graphene-impregnated microfiber fabric, which will be described herein in concurrence with FIG. 2.

With reference now to FIG. 2, method 200 includes, at 202, providing a microfiber substrate comprising polymer fibers. In one example and with reference to FIG. 3, the process of providing a microfiber substrate may begin by processing polymer pellets 302 in fiber formation steps at 304, such as via melting and extruding through one or more extrusion spinnerets to produce continuous strands (filaments) or short strands (staple fibers) that are formed into yarns. The yarns may then undergo material processing steps at 306, such as crimping, felting, rolling, folding, stretching and/or pressing the yarns into a microfiber substrate 308. In some examples, the microfiber substrate 308 may comprise a sheet of loosely entangled fibers that form a felt-like structure. In some examples, the microfiber substrate 308 may have a thickness of approximately 1 mm. In some examples and with reference again to FIG. 2, at 203 the microfiber substrate 308 may comprise one or more of a spun fiber composition and a brushed knit composition.

With reference again to FIG. 3, the polymer pellets 302 and resulting fibers of the formed microfiber substrate 308 include one or more polymers, such as polyester, polyamide, acrylic, rayon, nylon, polyethylene, polypropylene, polystyrene, other suitable polymers, and/or a combination thereof. The polymer pellets 302 and the microfiber substrate 308 may also include one or more additional components that are included as fillers, binders, or thickeners, such as natural components that come with the raw material of the pellets 302, or other polymers, such as a water-soluble synthetic polymer. In these examples, the formed microfiber substrate 308 may be placed in a filler removal bath 310 to remove some or substantially all of the filler components.

Next, at 314, the microfiber substrate 308 is dried via hanging, baking, or other suitable drying processes. The microfiber substrate 308 may then undergo a splitting process, at 316, in which the polymer undergoes a chemical process that splits the microfibers, creating numerous openings in the microfibers that increase surface area, thereby enhancing absorbent properties of the microfibers. In other examples, the microfibers may not be split, such as in the production of microfiber fabric for use in products that are not intended to be absorbent. The above-described steps may result in a microfiber substrate obtained for step 202 of FIG. 2.

Next and with reference again to FIG. 2, method 200 includes, at 204, mixing graphene into a polymer-based dispersion to create a graphene-impregnated polymer-based dispersion. As noted above, in some examples the graphene takes the form of graphene nanoplatelets. In different examples the graphene may take the form of a graphene-based paste, at 206, a liquid graphene dispersion (e.g. water-based or other solvent-based), at 208, or a graphene powder, at 210. Any suitable polymer-based dispersion may be utilized, including but not limited to a polyurethane (PU) dispersion or a polyester dispersion. FIG. 3 specifically shows by example a graphene-based paste 318 mixed into a polyurethane-based dispersion 320. In some examples, using a graphene-based paste can allow methods of the present disclosure to introduce a higher load amount of graphene into the polymer-based dispersion as compared to a graphene powder or liquid graphene dispersion. Advantageously, such higher load amounts can be utilized to produce graphene-impregnated microfiber fabrics having lower surface resistivity values.

Polyurethane-based dispersion 320 may include raw polyurethane (e.g. aliphatic polyurethane), or polyurethane-based dyes or pigments, as examples. Solvents for the polymer-based dispersion may include water, dimethylformamide (DMF), methylethylketone (MEK), silver/copper ions, and/or other suitable solvents. The graphene-based paste 318 may be formed by mixing graphene and a thickener in water to form a thickened, relatively high viscosity fluid. Regardless of the form in which the graphene is added, the graphene may be mixed into the dispersion using any suitable method, such as via mechanical mixers, heating, agitation, etc., to disperse the graphene substantially evenly throughout the dispersion.

In some examples, the resulting graphene-impregnated polymer-based dispersion may comprise between approximately 0.5% by weight and approximately 35% by weight of graphene, as shown at 212, and in some examples may comprise approximately 15% by weight of graphene, as shown at 214. In different examples the load level of graphene in the dispersion may be varied based on, among other factors, one or more desired graphene-related properties or characteristics in an end product that incorporates the resulting fabric. For example, for end products supporting antimicrobial/antiviral properties and not requiring electrical conductivity, a relatively lower amount of graphene may be mixed into the polymer-based dispersion. In other example products where electrically conductive graphene-impregnated microfiber fabric is desired, such as to support sensor(s), a higher amount of graphene may be mixed into the polymer-based dispersion to achieve a lower surface resistivity in the resulting fabric.

As described in more detail below and in one potential advantage of the present disclosure, in examples where the graphene-impregnated polymer-based dispersion includes greater than approximately 15% by weight of graphene, methods of the present disclosure may produce graphene-impregnated microfiber fabrics embodying electrical conductivity sufficient to enable a wide variety of applications, such as integrating circuitry and electrically coupling components via the fabrics. Further and as explained below, by utilizing a graphene-impregnated polymer-based dispersion to produce the graphene-impregnated microfiber fabrics, the graphene is thoroughly distributed throughout the microfiber substrate 308 to advantageously provide such electrically-conductive properties throughout the composition of the substrate. It will be understood that a range of weights by volume of graphene may be used to achieve different end products with different characteristics and different magnitudes of particular properties.

Next, method 200 includes, at 216, forming a graphene-impregnated microfiber fabric by immersing the microfiber substrate in the graphene-impregnated polymer-based dispersion to coat the polymer fibers of the microfiber substate with the graphene and the polymer of the polymer-based dispersion. The microfiber substrate may be immersed in the graphene-impregnated polymer-based dispersion for an amount of time ranging from five seconds to 60 minutes, in some examples. In different examples, different immersion times may be utilized with different concentrations of graphene in the graphene-impregnated polymer-based dispersion to produce graphene-impregnated microfiber fabrics having different collections of desired properties. Further, as noted above and in another potential advantage of the present disclosure, immersing the microfiber substrate 308 in the graphene-impregnated polyurethane-based dispersion 324 causes the graphene and the polyurethane to penetrate the substrate substantially evenly and throughout substantially all of the fibers of the substrate. In this manner, the polyurethane operates to both bind the graphene to the fibers, as well as bind and provide structural integrity to the microfiber substrate.

As noted above, in some examples the graphene-impregnated polymer-based dispersion includes greater than approximately 15% by weight of graphene. In these examples, methods of the present disclosure may produce graphene-impregnated microfiber fabrics that exhibit a surface resistivity below approximately 10⁶Ω, and thus embody electrical conductivity advantageously distributed throughout the microfiber substrate 308. Advantageously, such fabrics may accommodate and electrically couple a variety of electronic components, as noted above. In some examples where the graphene-impregnated polymer-based dispersion includes approximately 15% by weight of graphene, the methods of the present disclosure produce graphene-impregnated microfiber fabrics that exhibit a surface resistivity of between approximately 10⁷Ω and approximately 10⁸Ω. In these examples, such a surface resistivity advantageously enables the microfiber fabric to exhibit electrostatic dissipative properties.

With reference again to FIG. 2, method 200 further includes, at 218, removing the graphene-impregnated microfiber fabric from the graphene-impregnated polymer-based dispersion. FIG. 3 shows that in some examples, after removal the graphene-impregnated microfiber fabric 308 may be placed into a water bath 326, which may help remove any excess solvents or filler component(s).

Method 200 also includes, at 220, drying the graphene-impregnated microfiber fabric (depicted in FIG. 3 at 330). Drying may include hanging and/or baking the graphene-impregnated microfiber fabric. FIG. 3 depicts a resulting graphene-impregnated microfiber fabric 332. The fabric may undergo any suitable finishing processes, depending on the fabric application, such as dyeing, buffing, embossing, heat finishing, chemical finishing, etc.

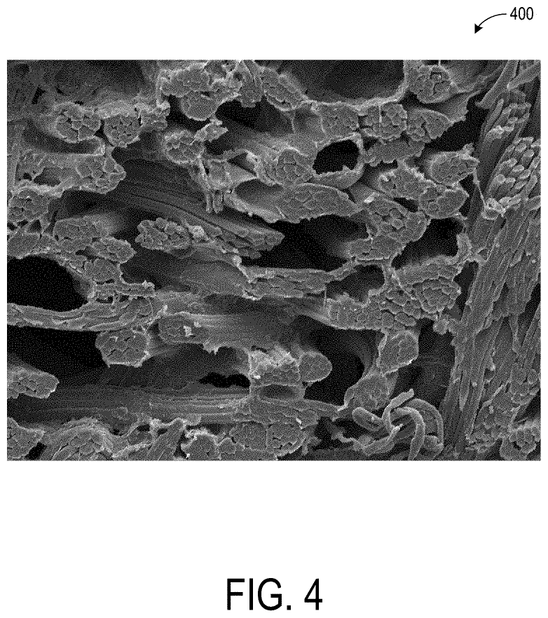

FIG. 4 shows an electron microscope image 400 of an example graphene-impregnated microfiber fabric produced according to example methods described herein. As described above, by immersing a microfiber substrate in a graphene-impregnated polymer-based dispersion, rather than printing, laminating, or coating graphene onto the exterior surface of a microfiber fabric after its construction, the graphene bonds with the microfibers such that the graphene contributes to the structure of the microfibers throughout the substrate. This allows the graphene to be distributed substantially throughout the entirety of the produced fabric, such that the fabric has a uniform appearance and feel along with substantially evenly distributed properties, such as electrical and thermal conductivity, enhanced strength and structural integrity, antimicrobial, antibacterial, and antiviral activity, anti-static activity, anti-odor, and/or flame self-extinguishing properties.

Another example provides a method of producing a graphene-impregnated microfiber fabric, the method comprising, providing a microfiber substrate comprising polymer fibers, mixing graphene into a polymer-based dispersion to create a graphene-impregnated polymer-based dispersion, forming the graphene-impregnated microfiber fabric by immersing the microfiber substrate in the graphene-impregnated polymer-based dispersion to coat the polymer fibers of the substrate with the graphene and the polymer of the polymer-based dispersion, removing the graphene-impregnated microfiber fabric from the graphene-impregnated polymer-based dispersion, and drying the graphene-impregnated microfiber fabric. The polymer fibers may additionally or alternatively include polyester fibers and/or nylon fibers. The polymer-based dispersion may additionally or alternatively include polyurethane. Mixing the graphene comprises mixing a graphene-based paste into the polymer-based dispersion. Mixing the graphene may additionally or alternatively include mixing a water-based graphene dispersion into the polymer-based dispersion. Mixing the graphene may additionally or alternatively include mixing a graphene powder into the polymer-based dispersion. The graphene-impregnated polymer-based dispersion may additionally or alternatively include between approximately 0.5% and approximately 35% by weight of graphene. The graphene-impregnated polymer-based dispersion may additionally or alternatively include approximately 15% by weight of graphene. The graphene-impregnated microfiber fabric may additionally or alternatively exhibit a surface resistivity of between approximately 10⁷Ω and approximately 10⁸Ω. The graphene-impregnated microfiber fabric may additionally or alternatively exhibit a surface resistivity of less than approximately 10⁶Ω.

Another example provides a graphene-impregnated microfiber fabric, comprising a microfiber substrate comprising polymer fibers, graphene coating the polymer fibers, and a polymer material coating the polymer fibers and bonding the graphene to the polymer fibers. The polymer fibers may additionally or alternatively include polyester fibers. The polymer fibers may additionally or alternatively include nylon fibers. The polymer material may additionally or alternatively include polyurethane. The graphene-impregnated microfiber fabric may additionally or alternatively exhibit a surface resistivity of between approximately 10⁷Ω and approximately 10⁸Ω.

Another example provides a method of producing a graphene-impregnated microfiber fabric, the method comprising providing a microfiber substrate comprising polyester fibers, mixing a graphene-based paste comprising graphene nanoplatelets into a polyurethane-based dispersion to create a graphene-impregnated polyurethane-based dispersion, forming the graphene-impregnated microfiber fabric by immersing the microfiber substrate in the graphene-impregnated polyurethane-based dispersion to coat the polyester fibers of the substrate with the graphene nanoplatelets and polyurethane, removing the graphene-impregnated microfiber fabric from the graphene-impregnated polyurethane-based dispersion, and drying the graphene-impregnated microfiber fabric. The microfiber substrate may additionally or alternatively include nylon fibers. The graphene-impregnated polyurethane-based dispersion may additionally or alternatively include between approximately 0.5% and approximately 35% by weight of graphene. The graphene-impregnated polyurethane-based dispersion may additionally or alternatively include approximately 15% by weight of graphene. The graphene-impregnated microfiber fabric may additionally or alternatively exhibit a surface resistivity of between approximately 10⁷Ω and approximately 10⁸Ω.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of producing a graphene-impregnated microfiber fabric, the method comprising:
providing a microfiber substrate comprising polymer fibers;
mixing graphene into a polymer-based dispersion to create a graphene-impregnated polymer-based dispersion;
forming the graphene-impregnated microfiber fabric by immersing the microfiber substrate in the graphene-impregnated polymer-based dispersion to coat the polymer fibers of the substrate with the graphene and the polymer of the polymer-based dispersion;
removing the graphene-impregnated microfiber fabric from the graphene-impregnated polymer-based dispersion; and
drying the graphene-impregnated microfiber fabric.

2. The method of claim 1, wherein the polymer fibers comprise polyester fibers and/or nylon fibers.

3. The method of claim 1, wherein the polymer-based dispersion comprises polyurethane.

4. The method of claim 1, wherein mixing the graphene comprises mixing a graphene-based paste into the polymer-based dispersion.

5. The method of claim 1, wherein mixing the graphene comprises mixing a liquid graphene dispersion into the polymer-based dispersion.

6. The method of claim 1, wherein mixing the graphene comprises mixing a graphene powder into the polymer-based dispersion.

7. The method of claim 1, wherein the graphene-impregnated polymer-based dispersion comprises between approximately 0.5% and approximately 35% by weight of graphene.

8. The method of claim 1, wherein the graphene-impregnated polymer-based dispersion comprises approximately 15% by weight of graphene.

9. The method of claim 1, wherein the graphene-impregnated microfiber fabric exhibits a surface resistivity of between approximately 10⁷Ω and approximately 10⁸Ω.

10. The method of claim 1, wherein the graphene-impregnated microfiber fabric exhibits a surface resistivity of less than approximately 10⁶Ω.

11. A graphene-impregnated microfiber fabric, comprising:
a microfiber substrate comprising polymer fibers;
graphene coating the polymer fibers; and
a polymer material coating the polymer fibers and bonding the graphene to the polymer fibers.

12. The fabric of claim 11, wherein the polymer fibers comprise polyester fibers.

13. The fabric of claim 11, wherein the polymer fibers comprise nylon fibers.

14. The fabric of claim 11, wherein the polymer material comprises polyurethane.

15. The fabric of claim 11, wherein the graphene-impregnated microfiber fabric exhibits a surface resistivity of between approximately 10⁷Ω and approximately 10⁸Ω.

16. A method of producing a graphene-impregnated microfiber fabric, the method comprising:
providing a microfiber substrate comprising polyester fibers;
mixing a graphene-based paste comprising graphene nanoplatelets into a polyurethane-based dispersion to create a graphene-impregnated polyurethane-based dispersion;
forming the graphene-impregnated microfiber fabric by immersing the microfiber substrate in the graphene-impregnated polyurethane-based dispersion to coat the polyester fibers of the substrate with the graphene nanoplatelets and polyurethane;
removing the graphene-impregnated microfiber fabric from the graphene-impregnated polyurethane-based dispersion; and
drying the graphene-impregnated microfiber fabric.

17. The method of claim 16, wherein the microfiber substrate further comprises nylon fibers.

18. The method of claim 16, wherein the graphene-impregnated polyurethane-based dispersion comprises between approximately 0.5% and approximately 35% by weight of graphene.

19. The method of claim 16, wherein the graphene-impregnated polyurethane-based dispersion comprises approximately 15% by weight of graphene.

20. The method of claim 16, wherein the graphene-impregnated microfiber fabric exhibits a surface resistivity of between approximately 10⁷Ω and approximately 10⁸Ω.
